(19) United States
(12) Patent Application Publication
(10) Pub. No.: US 2003/0208918 A1
(43) Pub. Date: Nov. 13, 2003

(54) Teaching aid for teaching addition and subtraction

(76) Inventor: Jeffrey M. Burke, Williamsville, NY (US)

Correspondence Address: PHILLIPS, LYTLE, HITCHCOCK, BLAINE & HUBER LLP, 3400 HSBC CENTER, BUFFALO, NY, 14203-3509, US

(21) Appl. No.: 10/141,886

(22) Filed: May 9, 2002

(51) Int. Cl. G01B 3/04

(52) U.S. Cl. 33/484

(57) ABSTRACT

The present invention provides an improved teaching aid for teaching addition and subtraction of real numbers which may be easily mastered by children or students. The teaching aid includes a slide (20) and a rule (30). The rule is inscribed with a scale (31). The slide is inscribed with a pointer (25) and indicia (21, 22, 23, 24) indicating the appropriate movement of the slide relative to the scale as a function of the sign of the real numbers desired to be added or subtracted. In certain aspects of the invention, the indicia include arrows (23, 24, 43, 44), and positive and negative signs, and combinations thereof. The slide and the rule are so configured and arranged that the pointer (25) and the scale (31) are in relative alignment. In some aspects, the rule is inscribed with one or more real numbers (32, 32a, 32b, 32c).

### TECHNICAL FIELD

The present invention relates generally to a teaching aid, and more particularly to a low cost, easy-to-use teaching aid for teaching addition and subtraction to, among others, elementary school and middle school children.

### BACKGROUND ART

The concept of addition and subtraction of positive and negative numbers is not easily comprehended by children or students. In particular, teachers and educators often have difficulty explaining to students, and students often have difficulty understanding, the concept of addition and subtraction of negative numbers. Teachers and educators frequently use number lines on chalkboards, in students' work papers, in textbooks or in computer programs to assist in explaining these mathematical concepts. Other methods of teaching addition and subtraction involve the use of multi-colored algebra tiles, with negative numbers being represented by one or more colors and positive numbers being represented by one or more different colors. In addition, students are often asked to memorize rules to assist them in correctly solving such addition and subtraction problems. For example, (a) the addition of two negative numbers always results in a negative number, and the addition of two positive numbers always results in a positive number, or (b) when you add a negative number, you move to the left on a number line, and when you subtract a negative number, you move to the right, or (c) when adding two negative numbers, first add the absolute values of the two numbers and then place a negative sign in front of the result.

Calculators and computers may assist students in performing such calculations, but fail to teach or explain the underlying concepts. Other disadvantages of such existing methods are that they often create confusion in students or merely teach students by rote memorization, which is not considered to be the best method for students to obtain proficiency in this and other areas of mathematics.

Teachers and educators often search for inexpensive teaching aids which are easily manipulated and which encourage participatory learning by students. It is highly desirable to utilize such easily manipulatable, low cost teaching aids to increase the learning capabilities of students. The invention described herein is an example of such a teaching aid.

The principal object of the present invention is to provide a simple and inexpensive teaching aid for the teaching of addition and subtraction of real numbers which may be easily mastered by a child or student.

### DISCLOSURE OF THE INVENTION

With parenthetical reference to the corresponding parts, portions or surfaces of the disclosed embodiment, merely for purposes of illustration and not by way of limitation, the present invention provides a teaching aid for use in teaching the addition and subtraction of positive and negative real numbers.

In one aspect of the invention, the teaching aid includes a slide (20) and a rule (30). In one aspect, the rule is inscribed with a scale (31). The slide of the present invention is inscribed with a pointer (25) and indicia (21, 22, 23, 24) which indicate the appropriate movement of the slide relative to the scale as a function of the sign of the real numbers desired to be added or subtracted. The slide and the rule are so configured and arranged that the pointer (25) and the scale (31) are in relative alignment.

In certain aspects of the invention, the rule has a longitudinal surface (30, 50). In another aspect, the rule has a circular surface (70). In yet another aspect, the slide has a circular surface (60). In another aspect, the radius of the rule (70) is greater than the radius of the slide (60).

In another aspect of the invention, the slide includes a window (26). In another aspect, the scale is visible through the window. In yet another aspect of the invention, the slide is transparent (40).

In one aspect of the present invention, the rule has an edge portion (33), and the scale (31) is perpendicularly disposed along the edge portion. In another aspect, the scale (71) is radially disposed along the edge portion (73) of the rule.

In other aspects, the scale includes a plurality of linear marks. In another aspect of the invention, the scale includes linear marks (31) perpendicularly disposed to the edge portion of the rule. In another aspect of the invention, the linear marks are inscribed on the rule at fixed intervals.

In another aspect of the invention, the rule is inscribed with one or more real numbers (32,32a,32b,32c) associated with one or more corresponding linear marks. In another aspect, the inscribed real numbers are integers.

In another aspect of the invention, the scale includes a plurality of radial marks (71). In another aspect, the scale includes radial marks extending radially inward from the circumferential edge portion (73) of the rule. In another aspect of the invention, the radial marks are inscribed at fixed intervals.

In another aspect of the invention, the rule is inscribed with one or more real numbers (72, 72a, 72b, 72c) associated with one or more of the radial marks. In another aspect, the real numbers are integers.

In another aspect of the invention, the rule is inscribed with a plurality of real numbers. In another, the rule is inscribed with at least one positive real number and at least one negative real number. In another aspect, each positive real number is inscribed in one color, and each negative real number is inscribed in a different color.

In another aspect of the invention, the indicia include at least one arrow (23, 24, 43, 44). The indicia also include, in another aspect, positive (+) and negative (−) signs or combinations thereof (e.g. “++,” “+−” “−+,” and “−−”), or similar writings or abbreviations (e.g. “plus,” “minus,” “add,” “subtract,” “plus-minus,” “minus-plus,” “addnegative,” “add-positive,” “subtract-negative,” etc.).

In another aspect of the invention, the slide is slidably mounted on the rule for movement along substantially the full length of the rule. In another aspect, the slide is slidably mounted on the rule for movement about a common axis.

In another aspect, the teaching aid of the present invention includes a slide associated with a rule, which slide is inscribed with a pointer and indicia which indicate the appropriate movement of the slide relative to the scale as a function of the sign of the real numbers desired to be added or subtracted.

In another aspect of the invention, the rule and the slide are configured and arranged so as to produce an audible sound as the slide moves with relation to the rule.

The general object of the invention is to provide a simple device for use in teaching addition and subtraction.

Another object is to provide a low-cost device for use in teaching addition and subtraction.

Still another object is to provide a device for use in teaching addition and subtraction which is easy for children and students to manipulate, understand and master.

Another object of the invention is to reinforce with a physical teaching aid rules taught to students by teachers and educators, and through textbooks.

These and other objects and advantages will become apparent from the foregoing and ongoing written specification, the accompanying drawings and the appended claims.

### BRIEF DESCRIPTION OF THE DRAWINGS

FIG. 1 is a perspective view of the teaching aid of the present invention.

FIG. 2 is a top plan view of the teaching aid of the present invention.

FIG. 3 is a section view of the teaching aid of the present invention.

FIG. 4 is a top plan view of the slide of the present invention.

FIG. 5 is a perspective view of an additional embodiment of the teaching aid of the present invention.

FIG. 6 is a top plan view of an additional embodiment of the teaching aid of the present invention.

### DESCRIPTION OF THE PREFERRED EMBODIMENTS

At the outset, it should be clearly understood that like reference numerals are intended to identify the same structural elements, parts, portions or surfaces consistently throughout the several drawing figures, as such elements, parts, portions or surfaces may be further described or explained by the entire written specifications, of which this detailed description is an integral part. Unless otherwise indicated, the drawings are intended to be read together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, “radially”, etc.), simply refer to the orientation of the illustrated structure as the particular drawing figure faces the reader. Similarly, the terms “inwardly,” “outwardly” and “radially” generally refer to the orientation of a surface relative to its axis of elongation, or axis of rotation, as appropriate.

Referring now to the drawings, the present invention provides an improved teaching aid, of which a first embodiment is generally indicated in FIG. 1. In FIG. 1, the teaching aid is shown as having a slide 20 inscribed with a pointer 25, which slide is mounted on a rule 30 for movement relative to a scale 31 inscribed on the rule 30. The slide 20 and rule 30 are so configured and arranged that the pointer 25 and scale 31 are in relative alignment. As used herein, a rule is a ruler, sheet, panel or plane having one or more surfaces capable of inscription. For example, a rule may be a plastic, metal or wooden ruler, or an object in the shape of such a ruler. Another example of a rule is a circular dial plate. The rule has an edge portion or surface 33. A scale, as used herein, is a system of ordered marks or rulings spaced at regular intervals.

In this embodiment, the scale 31 is perpendicularly disposed along the edge portion 33 of the rule 30.

The slide is further inscribed with indicia 21,22,23,24 indicating the appropriate movement of the slide 20 relative to the scale 31 as a function of the sign—positive (+) or negative (−)—of the real numbers to be added or subtracted. For example, the indicia would indicate leftward movement if an addition problem contemplated addition of a negative real number, and rightward movement if a subtraction problem contemplated subtraction of a negative real number. As another example, the indicia 21, 23 would indicate movement to the left if an addition problem required the addition of a negative real number.

The indicia 21,22 also include, in the first embodiment, positive (+) and negative (−) signs and combinations thereof (e.g. “++,” “+−” “−+,” and “−−”), and may include similar writings or abbreviations (e.g. “plus,” “minus,” “add,” “subtract,” “plus-minus,” “minus-plus,” “add-negative,” “add-positive,” “subtract-negative,” etc.).

In addition, this embodiment includes positive and negative real numbers 32, 32a, 32b, 32c associated with the scale 31. The indicia include two arrows 23, 24 reflecting the appropriate movement of the slide 20, corresponding to the other indicia 21, 22. The preferred embodiment includes a window 26 wherein the scale 31 is visible through the window 26.

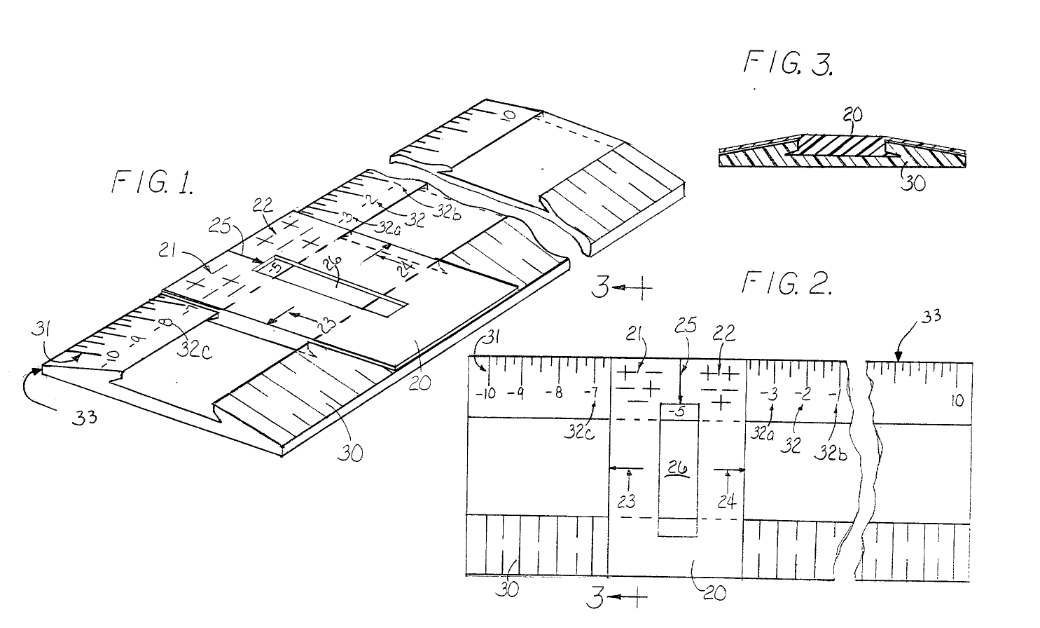

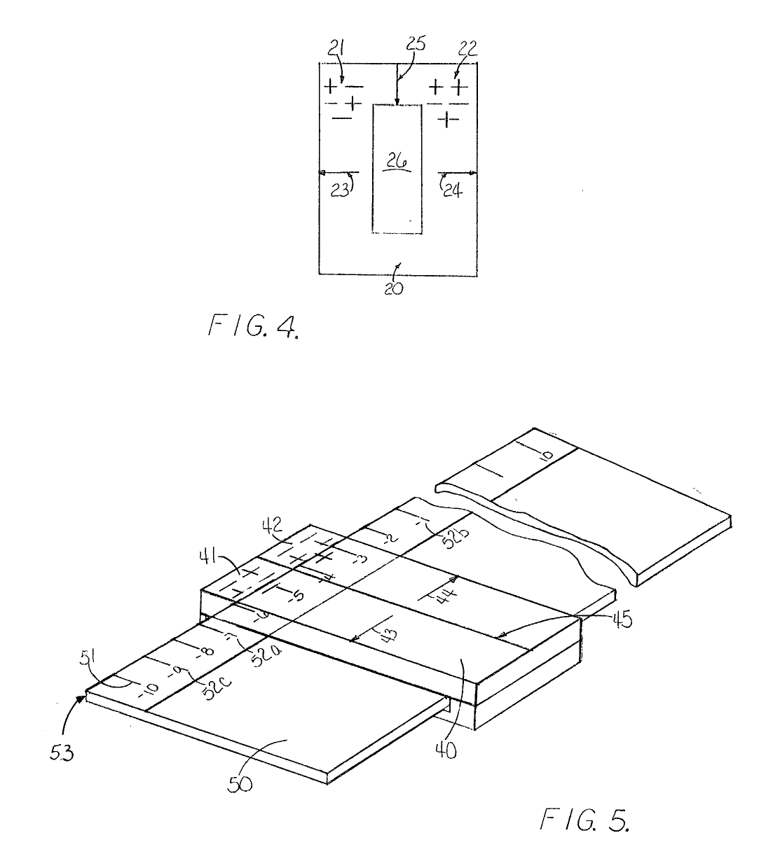

FIG. 2 illustrates a top plan view of the first embodiment containing the same elements, parts, portions and surfaces described above. FIG. 3 is a section view of same, and FIG. 4 is a top plan view of the slide of the first embodiment.

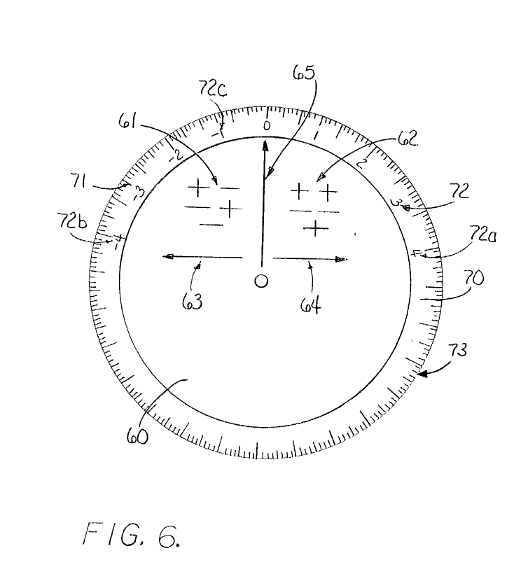

FIGS. 5 and 6 illustrate alternate embodiments of the present invention. In the alternate embodiment illustrated in FIG. 5, the teaching aid of the present invention includes a transparent slide 40 slidably mounted around a rule 50. The transparent slide is inscribed with indicia 41,42, 43,44, including combinations of positive and negative signs 41, 42, and left and right arrows 43, 44. As in the first embodiment, the indicia in this embodiment 41,42,43,44 indicate the appropriate movement of the slide 40 relative to the rule 50 as a function of the numbers to be added or subtracted. This embodiment also includes a pointer 45 in the form of a straight line.

The rule 50 is inscribed with a scale 51 perpendicularly disposed to an edge portion 53, and a series of positive and negative integers 52a, 52b, 52c associated with the scale 51.

In the alternate embodiment of FIG. 6, the teaching aid is shown as having a circular slide 60 inscribed with a pointer 65, which circular slide is mounted on a circular rule 70 for movement relative to a scale 71 inscribed on the rule 70. In this alternate embodiment, the radius of the slide 60 is smaller than the radius of the rule 70. The slide is further inscribed with indicia 61,62, 63,64 indicating the appropriate movement of the slide 60 relative to the scale 71 as a function of the sign of the real numbers to be added or subtracted. For example, the indicia 61 indicate counterclockwise movement if an addition problem required the addition of a negative real number, and the indicia 62, 64 indicate clockwise movement if a subtraction problem required subtraction of a negative number.

In this embodiment, the indicia include two arrows 63, 64 reflecting the appropriate movement of the slide 60, corresponding to the other indicia 61, 62.

This embodiment also includes positive and negative integers 72, 72a, 72b, 72c associated with the scale 71. The marks comprising the scale 71 extend radially inward from the edge portion 73 of the rule 70.

While there has been described what is believed to be the preferred embodiment of the present invention, those skilled in the art will recognize that other and further changes and modifications may be made thereto without departing from the spirit of the invention. Therefore, the invention is not limited to the specific details and representative embodiments shown and described herein. In the following claims, preamble language that is not specifically referred to in the body of a particular claim is to be construed as a mere statement of intended use and not as a limitation. Accordingly, various modifications may be made without departing from the spirit or scope of the general inventive concept as defined and differentiated by the following claims.

What is claimed is:

1. A device for teaching addition and subtraction of real numbers, comprising:
a rule inscribed with a scale;
a slide inscribed with a pointer and indicia indicating appropriate movement of said slide relative to said scale as a function of the sign of said real numbers;
wherein said slide and said rule are so configured and arranged that said pointer and said scale are in relative alignment.

2. The device of claim 1 wherein said rule has a longitudinal surface.

3. The device of claim 1 wherein said rule has a circular surface.

4. The device of claim 3 wherein said slide has a circular surface.

5. The device of claim 4 wherein the radius of said rule is greater than the radius of said slide.

6. The device of claim 1 wherein said slide comprises a window.

7. The device of claim 6 wherein said scale is visible through said window.

8. The device of claim 1 wherein said slide is transparent.

9. The device of claim 1 wherein said rule has an edge portion and wherein said scale is perpendicularly disposed along said edge portion.

10. The device of claim 1 wherein said rule has an edge portion and wherein said scale is radially disposed along said edge portion.

11. The device of claim 1 wherein said scale comprises a plurality of linear marks.

12. The device of claim 11 wherein said linear marks are inscribed on said rule at fixed intervals.

13. The device of claim 11 wherein said rule is inscribed with a real number, and wherein said real number is associated with one of said linear marks.

14. The device of claim 13 wherein said real number is an integer.

15. The device of claim 1 wherein said rule comprises an edge portion and said scale comprises a plurality of radial marks, wherein said radial marks extend radially inward from said edge portion.

16. The device of claim 15 wherein said radial marks are inscribed on said rule at fixed intervals.

17. The device of claim 15 wherein said rule is inscribed with a real number, and wherein said real number is associated with one of said radial marks.

18. The device of claim 17 wherein said real number is an integer.

19. The device of claim 1 wherein said rule is inscribed with a plurality of real numbers.

20. The device of claim 19 wherein said real numbers are integers.

21. The device of claim 1 wherein said rule is inscribed with at least one positive real number and at least one negative real number.

22. The device of claim 21 wherein each of such positive numbers is inscribed in one color and each of such negative numbers is inscribed in a different color.

23. The device of claim 1 wherein said indicia comprise at least one arrow.

24. The device of claim 1 wherein said slide is slidably mounted on said rule for movement along substantially the full length of said rule.

25. The device of claim 1 wherein said slide is slidably mounted on said rule for relative movement about a common axis.

26. The device of claim 1 wherein said rule and said slide are configured and arranged so as to produce an audible sound as said slide moves with relation to said rule.

27. A device for teaching addition and subtraction of real numbers, associated with a rule inscribed with a scale, comprising:
a slide inscribed with a pointer and indicia indicating appropriate movement of said slide relative to said scale as a function of the sign of said real numbers;
wherein said slide is so configured and arranged that said pointer and said scale are in relative alignment.

28. The device of claim 27 wherein said slide has a circular surface.

29. The device of claim 28 wherein said rule has a circular surface, and wherein the radius of said rule is greater than the radius of said slide.

30. The device of claim 27 wherein said slide comprises a window.

31. The device of claim 30 wherein said scale is visible through said window.

32. The device of claim 27 wherein said slide is transparent.

33. The device of claim 27 wherein said indicia comprise at least one arrow.

34. The device of claim 27 wherein said slide is slidably mounted on said rule for movement along substantially the full length of said rule.

35. The device of claim 27 wherein said slide is slidably mounted on said rule for relative movement about a common access.

36. The device of claim 27 wherein said rule and said slide are configured and arranged so as to produce an audible sound as said slide moves with relation to said rule.
